(19) United States
(12) Patent Application Publication
(10) Pub. No.: US 2005/0118995 A1
(43) Pub. Date: Jun. 2, 2005

(54) Radiocommunication module that runs a main software program the low-level layers of which are open to a cleint software program which is also run by the module

(76) Inventor: Jacques Montes, Le Perreux-Sur-Marne (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/490,995

(22) PCT Filed: Sep. 9, 2002
(86) PCT No.: PCT/FR02/03058

(30) Foreign Application Priority Data
Oct. 2, 2001 (FR) 01/12692

(51) Int. Cl. H04Q 7/20

(52) U.S. Cl. 455/425

(57) ABSTRACT

The invention relates to a radiocommunication module of the type that hosts and runs a main software program comprising applications that are used to manage the operating system (OS), radiocommunications (layer 3 GSM) and peripherals (HWL). According to the invention, each of said applications is associated with a set of level 1 run functions. Moreover, the inventive radiocommunication module hosts and runs at least one client software program comprising at least oen client application which is associated with a set of level 1 source functions. The main software program and/or the client software program comprise(s) a level 1 interface application that can be used to interface the level 1 source functions, which are associated with the client application, with the level 1 run functions, which are associated with the operating system management application and with at least one of the applications used to manage radiocommunications and peripherals. In this way, access to at least some of the functionalities of the main software program is provided to at least one client application.

The field of the invention is that of radio-communication systems, particularly, but not exclusively, in accordance with the GSM (Global System for Mobile Communications), the DCS 1800 (Digital Cellular System 1800 MHz), the PCS 1900 (Personal Communication System), the GPRS (General Packet Radio Service), or the UMTS (Universal Mobile Telecommunication System) standard.

More accurately, the invention relates to a radiocommunication module. It will be remembered that the radiocommunication module is an essential element of a radio telephone.

Customarily (first application), the radio communication module is included in a terminal or ME (Mobile Equipment) which engages with a SIM (Subscriber Identity Module) card.

Other applications have already been envisaged for the aforementioned radiocommunication module.

In particular a proposal has been made (second application) for the radiocommunication module to be incorporated into devices other than radiocommunication terminals, but that nonetheless require a wireless communication functionality. By way of example, we may cite telemetry devices (meter readings), alarm devices or again bank card reader devices.

A proposal has also been made (third application) for the radiocommunication module to be provided in an independent form: it is then known as a modem. A modem of this kind does not include any man/machine interface hardware component (screen, keyboard, loudspeaker, etc). It is intended to engage with third party equipment (supporting a customer software program), which does include man/machine interface hardware components. The third party equipment may particularly, but not exclusively, be a microcomputer.

Typically, the radiocommunication module hosts and runs a main software program including:
an operating systems management application, also known as an “OS” (Operating System) block, which manages the system aspects such as the task manager, the memory manager, the time delay manager, etc.;
a radiocommunication management application, also known as a “layer 3 GSM” block, which manages the network aspects such as outgoing and incoming call management, short text message receive and send management, etc. It will be noted that the “layer 3 GSM” block is able not to observe the totality of the GSM recommendations for 3 layers. It may also comply with another standard (DCS 1800, PCS 1900, GPRS, UMTS, etc);
an application for managing the peripheral devices that can be connected to the radiocommunication module, also known as an “HWL” (HardWare Layer) block. By peripheral devices are meant particularly, but not exclusively, a screen, a keyboard, a microphone, a loudspeaker, a serial bus, a GPIO (General Purpose Inputs/outputs) component, a battery, a SIM reader, etc;
a proprietary application, using the aforementioned three “OS”, “Layer 3 GSM” and “HWL” blocks in order to offer the user a plurality of functionalities specific to a device incorporating the radiocommunication module. It will be remembered that this device is for example a radio telephone (aforementioned first application), an “other device” (aforementioned second application) or else a modem (aforementioned third application).

In the present case, the main software program is a proprietary software program, developed by the radiocommunication module manufacturer. It includes a binary file containing particularly the proprietary application as well as the aforementioned “OS”, “Layer 3 GSM” and “HWL” blocks. Conventionally, this binary file is the result of a compilation of a plurality of source files (for example in “C” language), then a link editing between the compiled source files (also known as object files).

The current technique, according to which the main software program is a proprietary software program, has several drawbacks.

First of all, it does not allow a customer to develop his own application himself. Indeed, the customer has of necessity to have his application developed by the manufacturer of the radiocommunication module (in order to obtain the aforementioned proprietary application).

Another drawback of the current technique is that if the customer wishes to make modifications to the proprietary application, he again has of necessity to go through the manufacturer of the radiocommunication module. The customer is therefore not in control of the changes he wishes to make to his application and has to rely permanently on the resources of the manufacturer of the radiocommunication module.

The particular objective of the invention is to overcome these different drawbacks of the prior art.

More accurately, one of the objectives of the present invention is to provide a technique that allows a customer to develop his own application, then to embed it and to run it using a radiocommunication module. This application, known as a “customer application”, must be able to be developed by the customer himself, independently of the radiocommunication module manufacturer. It must replace the aforementioned “proprietary application”, within the radiocommunication module.

Another objective of the invention is to allow the customer to develop a “distributed” customer application, including a plurality of “task” applications carrying out a number of real-time tasks, among which the customer is able to specify priorities.

Another object is of the invention is to provide software architecture, within the radiocommunication module, which makes it possible to support a new radiocommunication module drive technique, which is straightforward and inexpensive (in terms of hardware and energy consumption).

It will be remembered that the current radiocommunication module control technique using third party equipment has several drawbacks. First of all, it requires a double set of resources (processor and memory). Indeed, the radiocommunication module includes a processor and a memory (first set of resources) and the third party equipment also has a processor and a memory (second set of resources). The aforementioned current technique is therefore expensive in terms of hardware and energy consumption. Another drawback of the aforementioned current technique is that the radiocommunication module is completely under the control of the third party equipment. Indeed the customer control software program, hosted and run by the third party equipment, is the “master”, whereas the main software program, hosted and run by the radiocommunication module, is the “slave”.

According to another objective of the invention, the new radiocommunication module control technique, supported by the new software architecture according to the invention, allows the radiocommunication module, when controlled by third party equipment, to be able to supervise (including act on) the operation of this control. In other words, the wish is that the radiocommunication module should not only play the role of a slave.

Yet another objective of the invention is, in the context of the aforementioned new radiocommunication module control technique, to facilitate the task of the customer in the process of developing his own customer application.

Another objective of the invention is to propose a straightforward and effective solution to the dialogue problems between customer sub-applications (main and secondary) arising from the implementation of a particular embodiment of the present invention in which:
the customer application is “distributed” in the aforementioned sense and includes:
a first “task” application, carrying out a first real-time task of executing control commands (for example AT commands),
a second “task” application, carrying out a second real-time task such that the second “task” application plays the role of the customer control application and/or the role of the customer supervision application;
the second “task” application itself includes:
a main customer sub-application,
at least one secondary customer sub-application.

These different objectives, as well as others which will emerge subsequently, are met in accordance with the invention by using a radiocommunication module, of the type that hosts and runs a main software program including: an operating systems (OS) management application, a (layer 3 GSM) radiocommunication management application and an application for managing the peripheral devices that can be connected to the radiocommunication module (HWL). According to the invention, each of said applications included in the main software program is associated with a set of level 1 executive functions. Said radiocommunication module additionally hosts and runs at least one customer software program including at least one customer application, associated with a set of level 1 source functions. Said main software program and/or said customer software program include(s) a level 1 interface application, allowing the level 1 source functions, associated with said customer application, to interface with the level 1 executive functions, associated with said operating system management application and with at least one of said radiocommunication management and peripheral device management applications. In this way said at least one customer application has access opened up to at least some of the functionalities of the main software program.

The general principle of the invention therefore consists in using two software programs (main and customer) that are able to interact together, and in hosting, on the embedded customer software program (at least) one customer application. In this way, the main software program no longer includes a proprietary main application. In other words access to lower layers of the radiocommunication module (the aforementioned “OS”, “layer 3 GSM” and “HWL” blocks), developed by the radiocommunication module manufacturer, is open to customer applications, developed by customers. The series of these lower layers is sometimes also called “Open-Stack” in the remainder of the description.

The new technique according to the invention may be seen as a software platform that allows customers to develop their own customer applications and to download them into the radiocommunication modules.

Customers are able to develop, independently of the radiocommunication module manufacturer, their own applications and then to embed them and have them run by the radiocommunication modules. Likewise, customers are able to modify or develop their customer applications without this requiring the intervention of the radiocommunication module manufacturer.

In this way, we may distinguish in accordance with the present invention the three following interfacing types, via the level 1 interface application:
interfacing of the customer application or applications with the “OS” and “layer 3 GSM” blocks;
interfacing of the customer application or applications with the “OS” and “HWL” blocks;
interfacing of the customer application or applications with the “OS”, “layer 3 GSM” and “HWL” blocks.

It will be noted that the customer application or applications are able to be contained in the customer software program in a number of forms:
either, there is a single customer application, contained in the customer software program in the form of a binary file. The level 1 interface application is in this case contained either in this binary file (which assumes that the object file containing the customer application has been subject to link editing with the object file containing the level 1 interface application), or in another binary file;
or there are a number of customer applications, contained in the customer software program in the form of the same binary file. The level 1 interface application is in this case contained either in this binary file (which assumes that the object files containing the customer applications have been subject to link editing with the object file containing the level 1 interface application), or in another binary file;
or there are a number of customer applications, contained in the customer software program in the form of a number of binary files (each binary file containing one or more customer applications). The level 1 interface application is in this case contained either in one of these binary files (which assumes, for the relevant binary file, that the object file or files containing the customer application or applications have been subject to link editing with the object file containing the level 1 interface application), or in another binary file.

It will be noted that the expression “level 1” is used to denote entities involved in relationships between customer application(s) and application(s) included in the main software program. These “level 1 entities” are particularly executive functions associated with the applications included in the main software program, the source functions associated with the customer application or applications, or again the interface application between customer application(s) and application(s) included in the main software program.

Subsequently a different expression is used, namely “level 2”, to denote entities involved in relationships between two customer applications, in the context of one particular embodiment of the invention relative to radiocommunication module control. These “level 2 entities” are particularly executive functions and source functions specific to the control commands (according to the AT standard, for example), or else the application for interfacing between them.

Preferentially, said customer software program includes a global initialisation customer application, and at least one customer task application carrying out at least one real-time task. The set of level 1 source functions associated with the global initialisation customer application includes a level 1 global initialisation source function, the role of which is to provide the main software program with information allowing it to initialise and interact with each customer task application.

In this way, the main software program only needs to know this level 1 global initialisation source function to be able to launch, when it so desires, the global initialisation customer application. It does not therefore need to know the dialogue points (level 1 message initialisation and processing source functions) for each customer task application. These dialogue points are presented in detail below.

Preferentially, said customer software program includes at least two customer task applications, each associated with a set of level 1 source functions and each carrying out at least one different real-time task. Said main software program and/or said customer software program include(s) means of sharing calculation resources between said customer task applications, so as to allow a multitask real-time operation.

To advantage, the set of level 1 source functions associated with each customer task application includes a level 1 initialisation source function, allowing said customer task application to be initialised. This level 1 initialisation source function is called on once by the main software program so as to initialise the task carried out by the customer task application involved.

Preferentially, said information provided by the global initialisation source function to the main software program includes:
the number of customer task applications to be initialised;
for each customer task application to be initialised, the corresponding level 1 initialisation source function.

Preferentially, the set of level 1 source functions associated with each customer task application includes a level 1 source function of receiving and processing a message from the main software program, one parameter of said level 1 receive and process source function being said message.

This level 1 message receives and process source function is called on each time the main software program sends a message to the relevant customer task application. Each customer application possesses its own level 1 message receive and process source function.

Preferentially, said information provided by the level 1 global initialisation source function to the main software program additionally includes, for each customer task application to be initialised, the level 1 receive and process source function.

In this way, the main software program has two dialogue points (level 1 source functions) with each customer application, namely the level 1 initialisation source functions and the level 1 receive and process source function.

In one particular embodiment of the invention, the set of level 1 source functions associated with each customer task application includes a level 1 source function of subscribing to a mailbox service managed by the main software program, allowing said customer task application to get itself allocated a mailbox which is specific to it and in which it wishes to receive information coming from at least one predetermined source.

Preferentially, each predetermined information source is a mailbox allocated to at least one main task carried out by the main software program, and containing information that said main task wishes to communicate to one or more other entities. The other entity or entities to which a main task wishes to communicate information are customer task applications and/or other main tasks.

In an advantageous embodiment of the invention, said customer software program includes at least:
a first customer application carrying out a first real-time task of executing control commands, sent to said first application by at least one customer control application and belonging to a predetermined set of control commands, said first customer application being based particularly on a set of level 2 executive functions, specific to the control commands and each allowing at least one of said control commands to be executed,
a second customer application carrying out a second real-time task such that said second customer application plays at least one of the following roles:_* the role of a customer control application, sending control commands to the first customer application, and receiving from the customer application responses arising from the execution of some of the control commands;_* the role of a customer supervision application, managing the execution of control commands sent by a customer control application, said customer application being external, hosted and run by third party equipment engaging with the radiocommunication module;_said second customer application being based particularly on a set of level 2 source functions, specific to the control commands and each allowing control commands or responses to control commands to be sent or received, to or from the first customer application,
a level 2 interface application, specific to the control commands, and allowing said level 2 source and executive functions to interface, said level 2 interface application itself being based on said level 1 interface application.

In this way, the present invention proposes a new software architecture within the radiocommunication module (opening up the lower layers to an embedded customer software program), which makes it possible to support a new radiocommunication module control technique which is straightforward and inexpensive.

This new radio communication module control technique consists in hosting on the radiocommunication module a customer software program including:
a first customer application capable of executing control commands (AT commands for example). In practice, this first customer application may be provided by the radiocommunication module manufacturer;
a second customer application, controlling and/or supervising the radiocommunication model, making the first customer application execute commands.

In the event of the second customer application controlling the radio communication module, the latter presents an autonomous and inexpensive operation. Indeed it does not have to engage with third party equipment, and the main software program and the customer software program use the same resources (same processor and same memory).

In the event of the second customer application supervising the radiocommunication module, the latter is not limited to the role of a slave in respect of the third party equipment which runs the customer control software program. Indeed, the second customer application manages the control requested by the (external) customer control software program, run by the third party equipment. It will be noted, that in this case, the embedded customer software program is an additional software program relative to the configuration of the prior art. However this additional software program is inexpensive since it uses the same resources (processor and memory) as the main software program which is also hosted by the radiocommunication module.

Preferentially, to allow the second customer application to play the role of the customer control application:
the second customer application includes means of sending control commands to the executive means included in the first customer application;
the first customer application includes means of sending responses, resulting from the execution of some of the control commands by the executive means included in the first customer application, to the second customer application;
the second customer application includes means of processing the responses sent to it by the first customer application.

Preferentially, to allow the second customer application to play the role of a customer supervision application:
the first customer application includes command switching means, as a function of a pre-set command switching policy, so as to transmit the control commands coming from the external customer application to the second customer application and/or to the executive means included in the first customer application;
the second customer application includes means of processing the control commands switched to it by said command switching means.

To advantage, the second customer application includes means of selecting the command switching policy applied by said command switching means, among a set of command switching policies such that respectively:
the control commands from the external customer application are transmitted only to the executive means included in the first customer application;
the control commands from the external customer application are transmitted only to the second customer application;
the control commands from the external customer application are transmitted to the executive means included in the first customer application and the second customer application.

To advantage, said command processing means take, for each command, at least one decision belonging to the group that includes:
sending the control command to the executive means included in the first customer application, the second customer application including to this end means for sending control commands to the executive means;
providing or not providing a response, solely as a function of at least one piece of information relating to the command, without executing the command, the second customer application including to this end means of sending the response to the external customer application, via the second customer application.

Preferentially, to allow the second customer application to play the role of the customer supervision application:
the first customer application includes response switching means, as a function of a pre-set response switching policy, so as to transmit responses, arising from the execution of some of the control commands by the executive means included in the first customer application, to the second customer application and/or to the external customer application;
the second customer application includes means of processing the responses switched to it by said response switching means.

To advantage, the second customer application includes means of selecting the response switching policy applied by said response switching means, among a set of response switching policies such that respectively:
the responses from the executive means are transmitted solely to the external customer application;
the responses from the executive means are transmitted solely to the second customer application;
the responses from the executive means are transmitted to the second customer application and to the external customer application.

Preferentially, said set of level 2 source functions includes particularly a function of processing a message from the first application, one parameter of said processing function being said message.

Preferentially, said set of control commands is a set of standard AT commands. This allows a rapid development of the first and second customer applications, since the AT commands are well-known and already used to develop external customer software programs (hosted by the third party equipment). It also facilitates the development of a second customer application strongly based on an existing external customer software program.

To advantage, said set of control commands includes, apart from the standard AT commands, an additional AT command, the so called load command, allowing the external customer application to load a new second customer application or the totality of a new customer software program into the radiocommunication module.

To advantage, said set of control commands includes, apart from the standard AT commands, an additional AT command, the so called disabling command, allowing the-external customer application to disable the second customer application.

In one particular embodiment of the invention, said second customer application includes a main customer sub-application and at least one secondary customer sub-application, slave of the main customer sub-application, the processing operations carried out by said second customer application being shared out between said main customer sub-application and said at least one secondary customer sub-application.

The present particular embodiment of the invention is therefore set in the context of the aforementioned new radiocommunication module control technique.

In this context, it is proposed to use not a second “single block” customer application, but a second “distributed” (“multi-block”) customer application including a main customer sub-application combined with one or more secondary customer sub-application(s). Each secondary customer sub-application is a slave sub-application, in launch and stop terms, of the main customer sub-application which calls upon it. But once initialised, the secondary customer sub-application has access, independently of the main customer sub-application, to all the executive functions offered by the first customer application (via a mechanism, detailed below, of subscribing to a service for sending messages from the first customer application).

The secondary customer sub-applications are “elementary blocks” which may be provided to customers by a third party developer (typically the radiocommunication module manufacturer). In this way, the customer's development work is reduced since he develops only the “main customer sub-application” which sub-contracts some processing operations by calling on one or more secondary customer sub-application(s).

It will be noted that the customer is himself also able to develop secondary customer sub-applications, if he wishes to be able to call on them in different main customer sub-applications which he is developing.

Preferentially, said level 1 initialisation source function is included in the set of level 1 source functions associated with the second customer task application and allows said main customer sub-application to be initialised.

Preferentially, the main customer sub-application is associated with a set of level 2 source functions including a level 2 source function of subscribing to a service of sending messages from the first customer application. At subscription, the main customer sub-application sends the first customer application the address of a level 2 message processing source function, in which the main customer sub-application wishes to receive messages from the first customer application.

It is this mechanism of subscribing to a service for sending messages from the first customer application which allows the main customer sub-application to call on all the executive functions offered by the first customer application, while being able to receive messages sent by the first customer application in the context of the execution of these functions.

Preferentially, the secondary customer sub-application is associated with a set of level 2 source functions including a level 2 source function of initialising the secondary customer sub-application, which is called upon by the main customer sub-application.

In this way, the main customer sub-application has to know only this dialogue point (“level 2 secondary customer sub-application initialisation source function”), and its counterpart presented below (level 2 secondary customer sub-application stop source function”). This is then a straightforward and effective solution to the dialogue problems between main customer sub-application and secondary customer sub-application. Indeed, the developer of a secondary customer sub-application does not have to write as many versions of it as there are customers wanting to incorporate it into their main customer sub-applications. He has only to indicate to them the two aforementioned dialogue points.

It should be noted that two developers of secondary customer sub-applications should be prevented from using identical dialogue points. To this end, provision may be made for example for each developer to request from a central service a unique identifier for each secondary customer sub-application which he wishes to develop.

Furthermore, the dialogue mechanism between the main customer sub-application and secondary customer sub-application particularly allows the secondary customer sub-application to send to the main customer sub-application the results of the execution of his task or tasks. The dialogue may be two-way or one-way.

Preferentially the set of level 2 functions associated with the secondary customer sub-application includes a level 2 source function of subscribing to a service of sending messages from the first customer application. At subscription, the secondary customer sub-application sends the first customer application the address of a level 2 source function of processing a message, in which the secondary customer sub-application wishes to receive messages from the first customer application.

Preferentially, said level 2 secondary customer sub-application initialisation source function includes at least one parameter that allows a dialogue mechanism to be implemented between the main customer sub-application and the secondary customer sub-application.

Preferentially, the set of level 2 source functions associated with the secondary customer sub-application includes a level 2 secondary customer sub-application stop source function, which is called upon by the main customer sub-application.

Preferentially, the set of level 2 source functions associated with the secondary customer sub-application includes a level 2 source function of unsubscribing from said service of sending messages from the first customer application.

The invention also relates to a process for opening up access to at least some of the functionalities of a main radiocommunication module software program. It is assumed that the radiocommunication module is of the type that hosts and runs a main software program that includes an operation system (OS) management application, a radiocommunication (layer 3 GSM) management application and an application for managing peripheral devices that can be connected to the radiocommunication module (HWL). According to the invention, each of said applications included in the main software program is associated with a set of level 1 executive functions. The radiocommunication module hosts and runs additionally at least one customer software program including at least one customer application, associated with a set of level 1 source functions. The main software program and/or said customer software program include(s) a level 1 interface application that allows the level 1 source functions, associated with said customer application, to interface with the level 1 executive functions, associated with said operating system management application and with at least one of said radiocommunication management and peripheral device management applications.

Other characteristics and advantages of the invention will emerge from reading the following description of a preferential embodiment of the invention, given by way of example and non-restrictively, and of the appended drawings, in which:

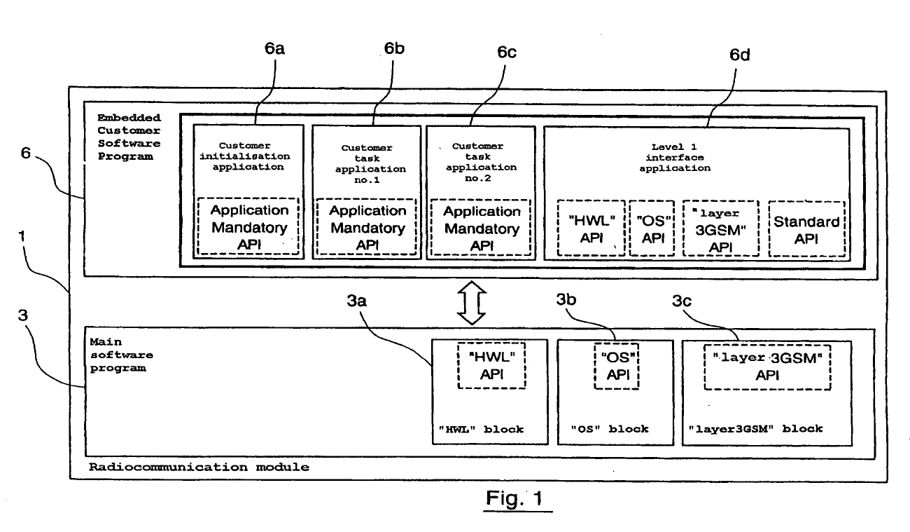

FIG. 1 shows a simplified diagram of a particular embodiment of a radiocommunication module according to the present invention, showing the main software program including the lower layers, and the customer software program including a level 1 interface application and a plurality of customer applications;

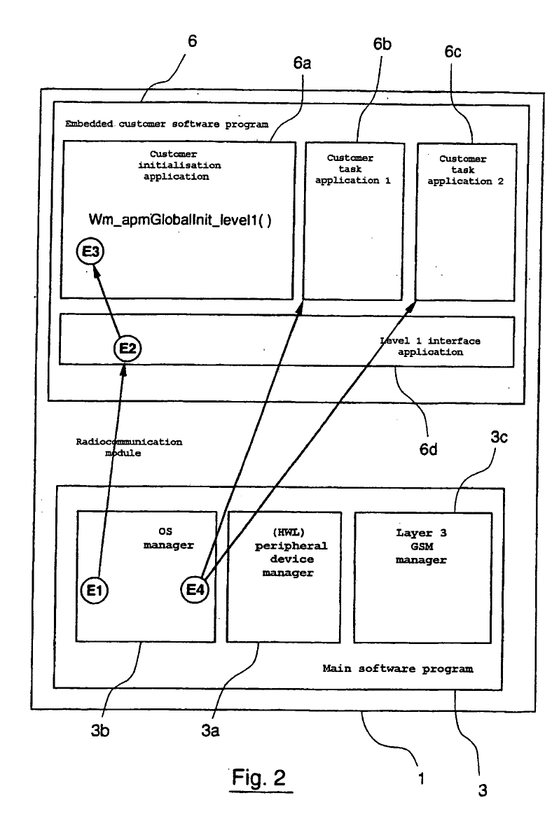

FIG. 2 shows a mechanism for launching customer applications included in the customer software program;

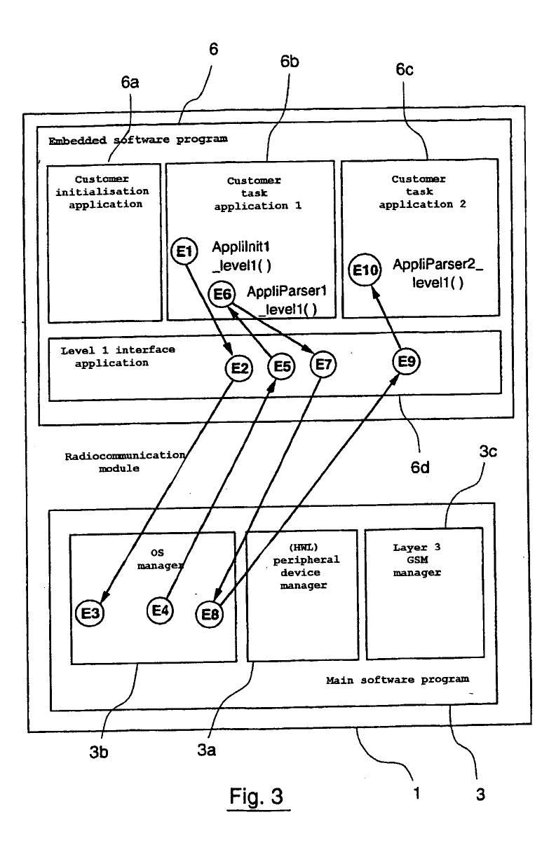

FIG. 3 shows a mechanism for dialogue between two customer task applications included in the customer software program;

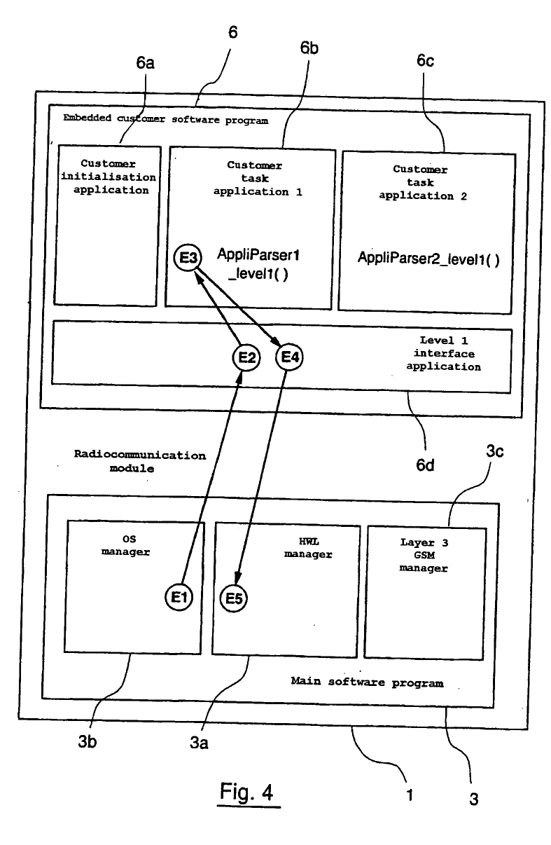

FIG. 4 shows a mechanism for calling, within a customer application, on a level 1 source function relating to the “HWL” block;

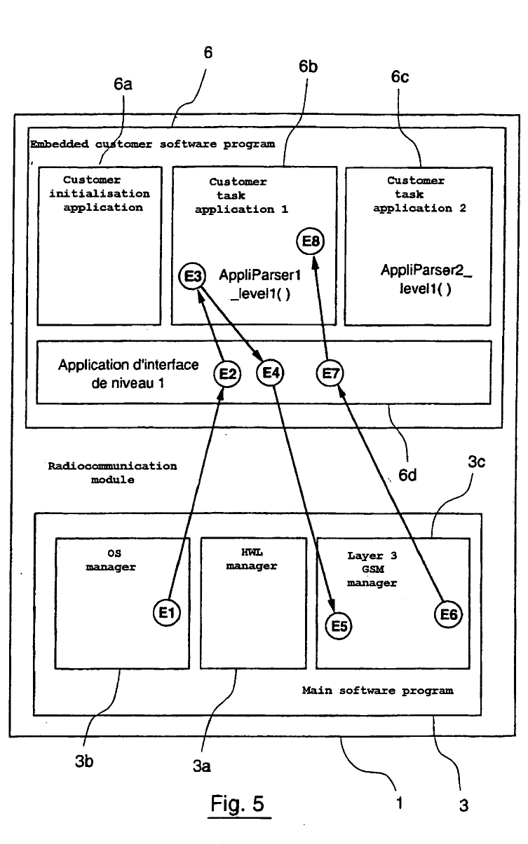

FIG. 5 shows a mechanism for calling, within a customer application, on a level 1 source function relating to the “layer 3 GSM” block;

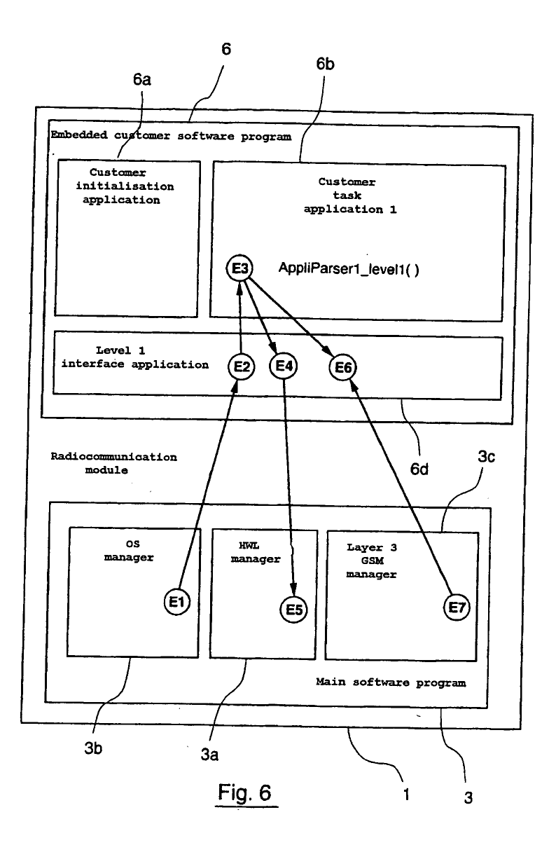

FIG. 6 shows a mechanism for calling, within a customer application, on a level 1 source function relating to the “HWL” and “layer 3 GSM” blocks;

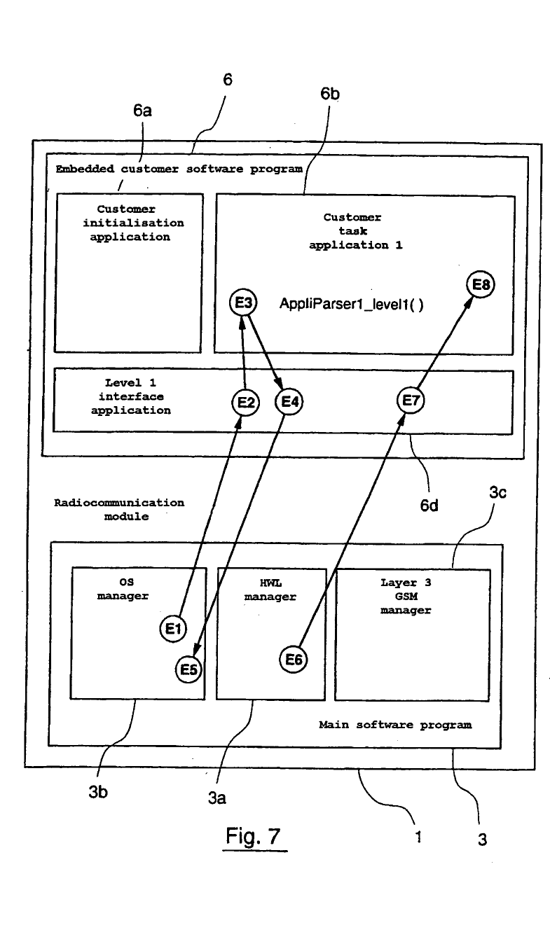

FIG. 7 shows a mechanism for a customer application to subscribe to a mailbox service managed by the main software program;

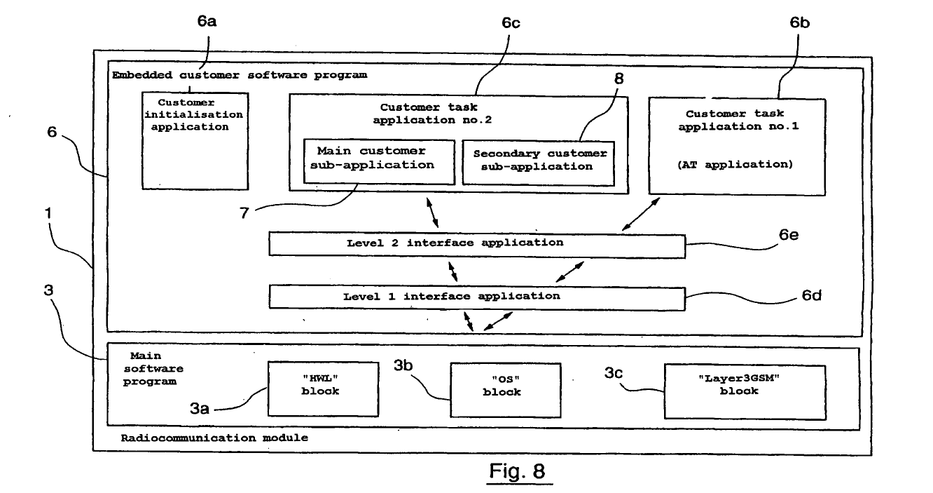

FIG. 8 shows a new radiocommunication module control technique, supported by the software architecture according to the invention, within the radiocommunication module.

The invention therefore relates to a radio communications module that hosts and runs, with the same set of resources (process and memory), a main software program and (at least) one embedded customer software program.

Conventionally, as shown in FIG. 1, the main software program 3 includes:
an “HWL” block 3a, which is an application for managing peripheral devices that can be connected to the radiocommunication module;
an “OS” block 3b, which is an operating system management application, managing system aspects such as the task manager, the memory manager, the time delay manager, etc;
a “layer 3 GSM” block, which is a radiocommunication management application, managing network aspects such as outgoing and incoming call management, short text message receive and send management, etc

Each of the three “HWL”, “OS” and “layer 3 GSM” blocks is associated with a set of level 1 executive functions.

In the particular embodiment shown in FIG. 1, the embedded customer software program 6 (a concept specific to the present invention) includes:
three customer applications, namely: a customer initialisation application 6a and two customer task applications, no.1 6b and no.2 6c, each of these customer applications being associated with a set of level 1 source functions;
a level 1 interface application 6d, allowing level 1 source functions (associated with the customer applications 6a, 6b and 6c) to interface with the level 1 executive functions (associated with the “HWL” 3a, “OS” 3b and “layer 3 GSM” 3c blocks).

In this way, the customer applications 6a, 6b and 6c communicate with the “HWL” 3a, “OS” 3b and “layer 3 GSM” 3c blocks, via the level 1 interface application 6d. To this end, each of these elements includes an “API” (Application Programming Interface). It will be remembered that an “API” interface is a description of the communication rules related to a certain functional set.

Each of the customer applications 6a, 6b and 6c includes an “Application Mandatory API” block forming an interface describing functions that have to be specified in the customer application. It is clear that the “Application Mandatory API” blocks of the different customer applications are able not to be strictly identical.

The level 1 interface application (or application interface library) 6d includes the 4 following blocks:
an “HWL API” block, forming an interface describing the access to the “HWL” block 3a, this interface describes functions that are in the level 1 application interface library;
an “OS API” block, forming an interface describing access to the “OS” block 3b, this interface describes functions that are in the level 1 application interface library;
a “layer 3 GSM API” Block, forming an interface describing access to the “layer 3 GSM” block 3c, this interface describes functions that are in the level 1 application interface library;
a “Standard API” block, forming an interface describing access to standard functions, this interface describes functions that are in the level 1 application interface library.

On the main software program side 3:
the “HWL” block 3a includes an “HWL API” block, the counterpart of the block of the same name included in the level 1 interface application 6d;
the “OS” block 3b includes an “OS API” block, the counterpart of the block of the same name included in the level 1 interface application 6d;
the “layer 3 GSM” block 3c includes a “layer 3 GSM API” block, the counterpart of the block of the same name included in the level 1 interface application 6d.

The level 1 interface application 6d is for example a binary file, which is presented in the form of a library (already compiled).

The main software program 3 is for example a binary file, resulting from link editing between a plurality of object files, themselves resulting from the compilation of source files containing particularly the “HWL” 3a, “OS” 3b and “layer 3 GSM” 3c blocks.

As far as customer applications 6a, 6b and 6c are concerned, the following variants are conceivable:
either the customer applications are contained in the customer software program 6 in the form of the same binary file, resulting from link editing involving particularly the object files that contain these customer applications;
or the customer applications are contained in the customer software program 6 in the form of several binary files (each binary file containing one or more customer applications).

The embedded customer software program 6 and the main software program 3 each use a different part of the same random access memory (RAM). The customer specifies the size of the memory stack necessary for the embedded customer software program to run properly. An attempt by one of the two software programs to access part of the random access memory reserved for the other software program causes the operation to stop.

A mechanism for launching the customer applications 6a, 6b and 6c included in the customer software program 6 will now be given, in relation to FIG. 2.

The elements included in the radiocommunication module 1, and already presented above in relation to FIG. 2, retain the same numerical references.

Each of the stages in this mechanism is shown in FIG. 2 by a circle in which the number of the relevant stage is inscribed. The same convention is adopted in the following figures in relation to the present invention (and which are described in detail in the remainder of the description).

The operation of this launch mechanism for customer applications 6a, 6b and 6c can be summarised as follows:
-stage “1”:the main software program 3 detects the presence of a customer initialisation application 6a and launches it by means of the OS manager 3b (another name for the “OS block” presented above);-stage “2”:the customer initialisation application 6a is launched via the level 1 interface application 6d. The latter calls within the customer initialisation application 6a on a (level 1) global initialisation source function. This source function (“wm_apmGlobalInit_level1( )”) is presented in detail in the remainder of the description;-stage “3”:within the customer initialisation application 6a, the source function “wm apmGlobalInit_level1( )” carries out a global initialisation consisting in providing the main software program 3 with the information allowing it to initialise and interact with each customer task application 6b and 6c. This information is for example as follows:
the number of customer task applications (two in the example described above) included in the embedded customer software program,
the dialogue functions associated with each of these customer task applications. These dialogue source functions (“AppliInit_nx_level1” and “AppliParser_nx_level1) are presented in detail in the remainder of the description;-stage “4”:within the main software program 3, the OS manager 3b initialises the customer task applications 6b and 6c by calling on their respective initialisation functions (AppliInit1_level1 and “AppliInit2_level1”).

A mechanism for dialogue between two customer task applications 6b and 6c included in the customer software program 6 is now presented in relation to FIG. 3.

The operation of this mechanism may be summarised as follows:
-stage “1”:the main software program 3 has initialised customer task application no.1 by calling on the source function “AppliInit1_level1( )” via the level 1 interface application 6d. This source function calls on a function (“wm_osStartTimer_level( )”) to trigger a time delay in the main software program;-stage “2”:the interface application 6d calls, within the main software program 3, on the appropriate executive function or functions;-stage “3”:within the main software program 3, the OS manager 3b informs customer task application no.1 which has set the time delay, through the interface application 6d;-stage “4”:when the time delay has expired, the OS manager 3b informs customer task application no.1 which has set the time delay, through the interface application 6d;-stage “5”:the dialogue with customer task application no.1 is conducted via the interface application 6d, which calls within customer task application no.1 on the aforementioned source function “AppliParser1_level1( )”;-stage “6”:within customer task application no.1, the source function “AppliParser1_level1( )” called upon sends a message to customer task application no.2, calling on the source function “wm_osSendMsg_level1( )” (presented in detail below);-stage “7”:the interface application 6d calls, within the main software program 3, on the appropriate executive function or functions;-stage “8”:within the main software program 3, the OS manager 3b carries out the processing requested which consists in sending the message to customer task application no.2, via the interface application 6d;-stage “9”:the dialogue with customer task application no.2 is conducted by the interface application 6d, which calls within customer task application no.2 on the aforementioned source function “AppliParser2_level1( )”;-stage “10”within customer task application no.2, the source function “AppliParser2_level1( )” called upon processes the message received.A mechanism for calling, within the customer application, on a level 1 source function relating to the “HWL” block is now given in relation to FIG. 4.

It is assumed that a time delay has been set by customer task application no.1, and that it is awaiting the expiry of this time delay.

In this example, calls to the HWL manager 3a are made by customer task application no.1. It is clear that this example remains valid if calls are made by any other customer task application of the embedded customer software program.

The operation of this mechanism may be summarised as follows:
stage “1”:when the time delay has expired, the OS manager 3b informs customer task application no.1 which set the time delay, through the interface application 6d;-stage “2”:the dialogue with customer task application no.1 is conducted via the interface application 6d, which calls within customer task application no.1 on the source function “AppliParser1_level1( )”;-stage “3”:within customer task application no.1, the source function “AppliParser1_level1( )” wishes for example to read a value stored in the Eeprom memory. To do this, it calls on the function “wm_hwlE2pRead_level1( )”;-stage “4”:the interface application 6d calls, within the main software program 3, on the appropriate executive function or functions in the HWL manager 3a;-stage “5”:within the main software program 3, the HWL manager 3a carries out the process requested, which consists in reading a value stored in the Eeprom memory. Then the customer task application no.1, via the interface applications 6d, returns the value read to customer task application no.1.

It is clear that the “wm_hwlE2pRead_level1( )” function, discussed above, is only one example among a plurality of level 1 source functions relating to the “HWL” block.

A mechanism for calling, within a customer application, on a level 1 source function relating to the “layer 3 GSM” block is now presented in relation to FIG. 5.

The assumptions and observations given above in commenting on FIG. 4 also apply to the present FIG. 5.

The operation of this mechanism can be summarised as follows:
-stage “1”:when the time delay has expired, the OS manager 3b informs customer task application no.1 which set the time delay, through the interface application 6d;-stage “2”:the dialogue with customer task application no.1 is conducted via the interface application 6d, which calls within customer task application no.1 on the source function “AppliParser1_level1( )”;-stage “3”:within customer task application no.1, the source function “AppliParser1_level1( )” wishes for example to send a message to the network. To do this, it calls on the function “wm_osRtkSend_level1( )”;-stage “4”:the interface application 6d calls, within the main software program 3, on the appropriate executive function or functions in the “Layer 3 GSM” manager 3c;-stage “5”:within the main software program 3, the “Layer 3 GSM” manager 3c carries out the process requested;-stage “6”:after processing (sending a message to the network) and obtaining a response from the network, the “Layer 3 GSM” manager 3c informs customer task application no.1, by the interface application 6d;-stage “7”:the dialogue with customer task application no.1 is conducted via the interface application 6d, which calls within customer task application no.1 on the aforementioned source function “AppliParser1_level1( )”;-stage “8”:within customer task application no.1, the source function “AppliParser1_level1( )” processes the message received.

It is clear that the function “wm_osRtkSend_level1( )”, discussed above, is only one example among a plurality of level 1 source functions relating to the “layer 3 GSM” bloc.

A mechanism for calling, within a customer application, on level 1 source functions relating to the “HWL” and “layer 3 GSM” blocks is now presented, in relation to FIG. 6.

In this example, it is assumed that customer task application no.1 wishes to read a value stored in the Eeprom memory, then to send a message to the network. It interacts to do this:
with the “HWL” block 3a (stages “1” to “5” corresponding to stages “1” to “5” in FIG. 4 described above),
then with the “Layer 3 GSM” block 3c (stages “3b”, 6 and “7” corresponding to stages “3” to “5” described above).

A mechanism for subscribing a customer application to a mailbox service managed by the main software program is now presented, in relation to FIG. 7.

The operation of this mechanism can be summarised as follows:
-stage “1”:when the time delay has expired, the OS manager 3b informs customer task application no.1 which set the timer, through the interface application 6d;-stage “2”:the dialogue with customer task application no.1 is conducted via the interface application 6d, which calls within customer task application no.1 on the source function “AppliParser1_level1( )”;-stage “3”:within customer task application no.1, the source function “AppliParser1_level1( )” wishes for example to request a subscription to information relating to the battery (load level indication, for example). To do this, it calls on a source function “wm_MbxSubscribe( )”of subscribing to a mailbox service management managed by the main software program, in order to get itself allocated a mailbox which is specific to it and in which it wishes to receive information coming from at least one predetermined source (the “battery” task in this example). This source function is presented in detail below;-stage “4”:the interface application 6d calls, within the main software program 3, on the appropriate executive function or functions in the “Layer 3 GSM” manager 3c;-stage “5”:within the main software program 3, the “OS” manager 3b carries out the process requested, which consists in this example in storing customer task application no.1 as addressee of the battery information;-stage “6”:when battery information is available, the HWL manager 3a sends it to customer task application no.1, via the interface application 6d. To do this, the HWL manager 3a consults the OS manager 3b internally, in order to find out the mailbox or mailboxes to which this information is to be addressed; -stage “7”:the dialogue with customer task application no.1 is conducted via the interface application 6d, which calls within customer task application no.1 on the aforementioned source function “AppliParser1_level1( )”;-stage “8”:within customer task application no.1, the source function “AppliParser1_level1( )” processes the battery information received.

It should be noted that the “OS” block 3b includes a task manager. The latter manages both the tasks offered by the main software program 3 and those offered by the customer software program 6. Each task is associated with a mailbox, which is assimilated to the source of the information generated by this task. In this way, each time one task wishes to communicate with another task, it uses the “OS” block task manager. Some tasks in the main software program 3 have information to communicate to the embedded customer software program 6. The latter is able to decide to which of its task applications it wishes to receive this information. In this way, in the example described above, the “battery” task of the main software program 3 has information which relates to battery management and it is customer task application no.1 which manages it (and therefore wishes to receive it in its mailbox).

A new radiocommunication module control technique, supported by the software architecture according to the invention, within the radiocommunication module, is now presented in relation to FIG. 8.

One particular embodiment of the software architecture of the radiocommunication module, according to the invention, has been presented above in relation to FIGS. 1 to 7. In this particular embodiment, the main software program 3 includes the “HWL” 3a, “OS” 3b and “layer 3 GSM” 3c blocks, and the embedded customer software program 6 includes a customer initialisation application 6a, two customer task applications (no.1) 6b and (no.2) 6c, and a level 1 interface application 6d.

In the remainder of the description, it is assumed that the control commands are AT commands. For more details in relation to AT commands, reference may be made on the one hand to the ETSI standards “GSM 07.05” and “GSM 07.07” and on the other hand to the V25ter recommendation of the ITU-T, which are inserted here for reference.

It is nonetheless clear that the present invention is in no way restricted to this type of control command.

In order to propose a new radiocommunication module control technique, it is specified that
customer task application no.1 carries out a first real-time task to execute the AT commands. The latter are sent to customer task application no.1 by (at least) one customer control application;
customer task application no.2 carries out a second real-time task allowing it to play at least one of the two following roles:
the role of a customer control application, sending AT commands to customer task application no.1, and receiving from customer task application no.1 responses, arising from the execution of some of the AT commands;
the role of a customer supervision application, managing the execution of AT commands sent by a customer control application, the so-called external customer application, hosted and executed by third party equipment engaging with the radiocommunication module.

Customer task application no.1 is based particularly on a set of level 2 executive functions, specific to AT commands and each allowing the execution of at least one of the AT commands.

The customer task application No 2 is based particularly on a set of level 2 source functions, specific to AT commands and each allowing AT commands or responses to AT commands to be sent or received, to or from customer task application no.1.

Provision is additionally made for a level 2 interface application 6e, specific to AT commands. It allows interfacing between level 2 source and executive functions. This level 2 interface is itself based on the level 1 interface application 6d.

It is important to distinguish properly between:
the sets of level 2 source and executive functions, specific to AT commands, and which are used in relations between the customer task applications no.1 and no.2;
the sets of level 1 source and executive functions, presented above in a detailed way in relation to FIGS. 1 to 7 and with appendix 1, and which are used in relations between each customer task application (no.1 or no.2) and the “HWL”, “OS” and “layer 3 GSM” blocks of the main software program 3.

In the event of customer task application no.2 playing the role of a customer control application, the operation of the control technique may be summarised as follows:
-stage “l”:customer task application no.2 calls on the source function (wm_atSendCommand_level2”) to send to customer task application no.1 one or more AT command(s). This source function is presented in detail in the remainder of the description;-stage “2”:the level 2 interface application calls on the appropriate executive function or functions within customer task application no.1.-stage “3”:customer task application no.1 executes the AT command or commands;-stage “4”:after execution, customer task application no.1 sends the AT response or responses to customer task application no.2 (if the aforementioned send command has been parameterised in this direction);-stage “5”:this (or these) response(s) is (are) sent via the level 2 interface application, which calls, within customer task application no.2, on the source function (“wm_apmAppliParser_level2”) of processing a message from customer task application no.1. One parameter of this processing source function is the message containing the aforementioned response or responses. This source function is presented in detail with the remainder of the description;-stage “6”:within customer task application no.2, the processing source function processes the response.

A detailed description will now be given of the case where customer task application no.2 plays the role of the customer supervision application.

In this second case, the radiocommunication module is not autonomous (unlike the first case), but is controlled by third party equipment with which it engages, for example via a serial link. An external customer application, hosted by the third party equipment, sends AT commands to the radiocommunication module, with a view to them being executed by the latter.

In this second case, in a transparent way for the external customer application, customer task application no.2 supervises the execution (or not) of the AT commands by customer task application no.1.

Customer task application no.2 (supervision application) is able to decide on the implementation, within the radiocommunication module, particularly of:
a mechanism for switching and processing AT commands, sent by the external customer application. Three variants for implementing this mechanism are for example proposed, according to which customer task application no.1 transmits the AT commands it receives: either solely to executive means included in customer task application no.1 (first variant), or solely to customer task application no.2 (second variant), or to both (third variant);
a mechanism for switching and processing AT responses, arising from the execution by executive means included in customer task application no.1 of AT commands. Three variants for implementing this mechanism are for example proposed, according to which the AT responses generated by customer task application no.1 are transmitted respectively solely to the external customer application (first variant), solely to customer task application no.2 (second variant), or else to both (third variant).

It will be noted that the first variant of each of the two aforementioned mechanisms (relating to AT commands and to AT responses respectively) means that customer task application no.2 is able to decide to be totally passive at certain times.

The second variant of the AT command switching and processing mechanism, which allows customer task application no.2 to filter the AT commands from the external customer application, is now presented.

The operation of this second variant of the AT command switching and processing mechanism may be summarised in two successive phases, namely:
a prior phase of selecting, by the external customer application, the (second) AT command switching policy, according to which AT commands are retransmitted solely to customer task application no.2, and
a phase of processing, according to the (second) command switching policy selected, the AT commands sent by the external customer application.

The second AT command switching policy prior selection phase includes the following stages:
-stage “1”:The customer task application no.2 calls on a source function (“wm_atCmdPreParserSubscribe_level2”) of subscribing customer task application no.1 to an AT command switching service, with one parameter of this subscription function indicating the choice of the second AT command switching policy. This source function is presented in detail in the remainder of the description;-stage “2”:the level 2 interface application calls, within customer task application no.1, on the appropriate executive function or functions, the so-called function of registering the subscription to the AT command switching service.-stage “3”:customer task application no.1 sets up the subscription requested by customer task application no.2, via the level 2 interface application.

Solely in the interests of simplification, it is assumed in the remainder of the description that the function or functions of registering the subscription to the AT command switching service are included, within customer task application no.1, in the AT command executive means. Also solely in the interests of simplification, it is assumed in the remainder of the description that the command switching means (discussed below) are included, within customer task application no.1, in the AT command executive means.

The AT command processing phase includes the following stages:
-stage “4”:the external customer application sends an AT command to customer task application no.1;-stage “5”:the serial link transmits the AT command to command switching means, included in the executive means included in customer task application no.1 and operating in accordance with the second AT command switching policy (selected during the prior phase);-stage “6”:without being executed by the executive means, the AT command is retransmitted solely to customer task application no.2;-stage “7”:the AT command is sent by the level 2 interface application, which calls, within customer task application no.2, on the source function (“wm_apmAppliParser_level2”) of processing a message from customer task application no.1, here parameterised particularly by a message containing the AT command and indicating that it is an “original” AT command. This source function is presented in detail in the remainder of the description;-stage “8”:within customer task application no.2, the processing source function processes the AT command.

This processing operation consists for example in sending the AT command back to the executive means included in customer task application no.1 (according to the mechanism corresponding to the first case described above). It may also consist of the arbitrary provision of a response by the customer task application no.2 itself, without the AT command being executed. In this case, the customer task application no.2 takes into account, for example, at least one piece of information relating to the relevant AT command (command type, nature of the parameter or parameters, etc.). Generally speaking, whatever processing operation is carried out, it is understood that customer task application no.2 “filters” the AT command.

The third variant of the AT command switching and processing mechanism, which allows customer task application no.2 to spy on AT commands from the external customer application, is now presented.

The operation of this third variant of the AT command swtching and processing mechanism may also be summarised in two successive phases, namely
a prior phase of selecting, by the external customer application, the (third) AT command switching policy, according to which AT commands are retransmitted not only to customer task application no.2, but also to the executive means included in customer task application no.1, and
a phase of processing, according to the (third) command switching policy selected, the AT commands sent by the external customer application.

The operation of this third variant differs from that of the second variant mainly in that:
in stage “1” of the prior phase, customer task application no.2 selects the third (and not the second) AT command switching policy;
in stage “6” of the processing phase, the AT command is transmitted to the executive means and a copy of this AT command is transmitted to customer task application no.2;
in stage “8” of the processing phase, within customer task application no.2, the processing source function processes the copy of the AT command;
the processing phase additionally includes a stage “7”, during which the executive means included in customer task application no.1 execute the AT command.

The second variant of the AT response switching and processing mechanism, which allows customer task application no.2 to filter the AT responses intended for customer task application no.1, is now presented.

The operation of this second variant of the AT response switching and processing mechanism may also be summarised in two successive phases, namely:
a prior phase of selecting, by the external customer application, the (second) AT response switching policy, according to which the AT responses generated by customer task application no.1 are transmitted solely to customer task application no.2;
a phase of processing, according to the (second) response switching policy selected, the AT responses generated by customer task application no.1.

The second AT response switching policy prior selection phase includes the following stages:
-stage “1”:customer task application no.2 calls on a source function (“wm_atRspPreParserSubscribe_level2”) of subscribing customer task application no.1 to an AT response switching service, with one parameter of this subscription function indicating the choice of the second AT response switching policy. This source function is presented in detail in the remainder of the description;-stage “2”:the level 2 interface application 6e calls, within customer task application no.1, on the appropriate executive function or functions, known as the function(s) of registering the subscription to the AT response switching service.-stage “3”:customer task application no.1 sets up the subscription requested by customer task application no.2, via the level 2 interface application.

Solely in the interests of simplification, it is assumed in the remainder of the description that the function or functions of registering the subscription to the AT response switching service arc included, within customer task application no.1, in the AT command executive means. Also solely in the interests of simplification, it is assumed in the remainder of the description that the response switching means (discussed below) are included, within customer task application no.1, in the AT command executive means.

The AT response processing phase includes the following stages:
-stage “4”:the external customer application sends an AT command to customer task application no.1;-stage “5”:the serial link transmits the AT command to the executive means included in customer task application no.1;-stage “6”:the executive means execute the AT command and generate an AT response;-stage “7”:response switching means, included in the executive means and operating in accordance with the second AT response switching policy (selected during the prior phase), send the AT response to customer task application no.2;-stage “8”:the AT response is sent by the level 2 interface application, which calls, within customer task application no.2, on the source function (“wm_apmAppliParser_level2”) of processing a message from customer task application no.1, here parameterised particularly by a message containing the AT response and indicating that it is an “original” AT response;-stage “9”:within the customer task application no.2, the processing source function processes the AT response. It is possible to talk here of a “filtering” of the AT responses by customer task application no.2.

The third variant of the AT response switching and processing mechanism, which allows customer task application no.2 to spy on the AT responses intended for customer task application no.1, is now presented.

The operation of this third variant of the AT response switching and processing mechanism may also be summarised in two successive phases, namely:
a prior phase of selecting, by the external customer application, the (third) AT response switching policy, according to which the AT responses are retransmitted not only to customer task application no.1, but also to customer task application no.2, and
a phase of processing, according to the (third) response switching policy selected, the AT responses generated by the customer task application no.1.

The operation of this third variant differs from that of the second variant mainly in that:
in stage “1” of the prior phase, customer task application no.2 selects the third (and not the second) AT response switching policy;
in stage “7” of the processing phase, the AT response is transmitted to the external customer application and a copy of this AT response is transmitted to customer task application no.2;
in stage “9” of the processing phase, within customer task application no.2, the processing source function processes the copy of the AT response;
the processing phase additionally includes a stage “8”, during which the response is sent through the serial link, and a stage “9” during which the external customer application receives and processes the response.

In a variant of the new radiocommunication module control technique according to the invention (one particular embodiment of which has been described above), customer task application no.2 6c is not “single block”, but “distributed” (“multi-block”). It includes a main customer sub-application 7 combined with one or more secondary customers sub-application(s) 8. Each secondary customer sub-application 8 is a slave sub-application, in launch and stop terms, of the main customer sub-application 7 which calls upon it. But once initialised, the secondary customer application 8 has access, independently of the main customer sub-application 7, to all the executive functions offered by the customer task sub-application no.1 (via a mechanism, detailed below, of subscribing to a service for sending messages from the customer task application no.1).

Each secondary customer sub-application is an “elementary block” which is able to be provided to the customer by a third-party developer (typically the radiocommunication module manufacturer). In this way, the customer's development work is reduced since he develops only the main customer sub-application, which subcontracts some processes by using one or more secondary customer sub-application(s).

It will be noted that the customer is himself also able to develop secondary customer sub-applications, if he wishes to be able to call on them in different main customer sub-applications which he is developing.

The implementation of several mechanisms in the context of the aforementioned variant of the new radiocommunication module control technique according to the invention is presented successively below.

Firstly a mechanism of launching the main customer sub-application 7 and of subscribing it to a service of sending messages from the customer task application no.1, is presented. The operation of this mechanism may be summarised as follows:
-stage “1”:customer task application no.1 detects the presence of a main customer application and launches it;-stage “2”:the main customer sub-application is launched via the level 2 interface application, which calls within the main customer sub-application on a main customer sub-application initialisation source function. This source function (“wm_apmAppliInit2_level1”) is presented in detail in the remainder of the description;-stage “3”:within the main customer sub-application, the source function (“wm_apmAppliInit2_level1”) initialises the main customer sub-application. As explained in detail in the next stages (“4” to “6”), this initialisation consists particularly in giving customer task application no.1 the address of a source function (for example “wm_apmAppliParser_level2”) that allows the main customer sub-application to receive messages from customer task application no.1; -stage “4”:the main customer sub-application calls on a source function of subscribing to a service of sending messages from customer task application no.1 (“wm_osMsgParserSubscribe_andlevel2”). This source function is presented in detail in the remainder of the description;-stage “5”:The level 2 interface application calls, within customer task application no.1, on the appropriate executive function or functions, known as the function of registering the subscription (or enrolment) to the service of sending messages intended for the main customer sub-application;-stage “6”:Customer task application no.1 sets up the subscription requested, via the level 2 interface application, by the main customer sub-application.

According to one variant, customer task application no.1 calls on the source function “wm_osMsgParserSubscribe_level2” when it so desires (independently of the execution of the initialisation source function).

A mechanism of launching the secondary customer sub-application 8 and of subscribing it to a service of sending messages from the customer task application no.1 is now presented.

The operation of this mechanism may be summarised as follows:
-stage “1”:the main customer sub-application, after receiving a message in its source function “wm_apmAppliParser_level2( )”, calls on a source function of the secondary customer sub-application, namely the initialisation source function of the secondary customer application 8 (“wm_app2Pipe_level2(init)”). This source function (which must be known to the main customer sub-application) is presented in detail in the remainder of the description; -stage “2” :within the secondary customer sub-application, the source function (“wm_app2Pipe_level2(init)”) initialises the secondary customer sub-application. As explained in detail in the following stages (“3” to “5”), this initialisation consists particularly in giving customer task application no.1 the address of the source function (for example “wm_app2MsgParser_level2”), allowing the secondary customer sub-application to receive messages from the customer task application no.1;-stage “3”:the secondary customer sub-application calls on the source function of subscribing to a service of sending messages from customer task application no.1 (“wm_osMsgParserSubscribe_level2”). This source function is presented in detail in the remainder of description; -stage “4”:the level 2 interface application calls, within the customer task application no.1, on the appropriate executive function or functions, known as the function of registering the subscription (or enrolment) to the service of sending messages intended for the secondary customer sub-application;-stage “5”:customer task application no.1 sets up the subscription requested, via the level 2 interface application 6e, by the secondary customer sub-application 8.

After it has been launched, the secondary customer sub-application 8 carries out its function (set of processing operations or tasks), autonomously relative to the main customer sub-application 7. As explained in detail below, it has at its disposal to this end the set of executive functions offered by the customer task application no.1.

According to one variant, the secondary customer sub-application 8 calls on the source function “wm_osMsgParserSubscribe_level2” when it so desires (independently of the execution of the initialisation source function of the secondary customer application).

It will be noted that the initialisation source function of the secondary customer sub-application may include at least one parameter that-allows a dialogue mechanism to be implemented between the main customer sub-application and the secondary customer sub-application. This characteristic of the invention is described in detail in the remainder of the description.

A mechanism of stopping the secondary customer sub-application 8 and unsubscribing it from the service of sending messages from customer task application no.1 is now presented.

The operation of this mechanism may be summarised as follows:
-stage “1”:the main customer sub-application 7, after receiving a message in its source function “wm_apmAppliParser_level2( )”, calls on a source function of the secondary customer sub-application 8, namely the source function of stopping the secondary customer sub-application (“wm_app2Pipe_level2(stop)”). This source function (which must be known to the main customer sub-application) is presented in detail in the remainder of the description;-stage “2”:within the secondary customer sub-application 8, the source function “wm_app2Pipe_level2(stop)” carries out the processing operations to stop the secondary customer sub-application. As explained in detail in the following stages (“3” to “5”), these processing operations consist particularly for the secondary customer sub-application in unsubscribing from the service of sending messages from customer task application no.1;-stage “3”:the secondary customer sub-application calls on the source function to unsubscribe from the service of sending messages from customer task application no.1 (“wm_osMsgParserUnsubscribe-level2”). This source function is presented in detail in the remainder of the description;-stage “4”:the level 2 interface application calls, within the customer task application no.1, on the appropriate executive function or functions, known as the unsubscribing (or subscription withdrawal) function(s) from the service of sending messages intended for the secondary customers on-application;-stage “5”:customer task application no.1 sets up the subscription stop requested, via the level 2 interface application, by the secondary customer sub-application.

An example of processing operations that can be carried out by the secondary customer application, to unload the main customer sub-application is now presented.

In this example, it is assumed that:
customer task application no.2 plays the role of the customer control application;
the processing operations consist of the sending by the secondary customer sub-application 8 of a command and the receipt of the corresponding response;
the secondary customer sub-application 8 has been initialised and that it is subscribed to the service of sending messages from customer task application no.1;
at subscription, the secondary customer sub-application 8 gave “wm_app2MsgParser_level2( )” as the message receive source function.

The operation of this example of processing operations may be summarised as follows:
-stage “1”:the secondary sub-application 8 calls on the function source of sending to customer task application no.1 one or more AT commands, so that the it executes them (and therefore carries out an “AT command processing operation)”. This source function (“wm_atSendCommand_level2”) is presented in detail in the remainder of the description;-stage “2”:the level 2 interface application 6e calls, within the executive means included in the customer task application no.1, on the appropriate executive function or functions, known as AT command processing function(s);-stage “3”:the executive means 4 execute the AT command or commands;-stage “4”:after execution, the executive means 4 send the AT response or responses to the secondary customer sub-application 8 (if the source function has been parameterised in this direction);-stage “5”:this (or these) response(s) is (are) sent, through the level 2 interface application, to the secondary customer sub-application 8;-stage “6”:within the secondary customer sub-application, the receive and process source function “wm_app2MsgParser_level2( )” processes the response. This source function is the one given by the secondary customer sub-application at subscription in respect of receiving messages from customer task application no.1. One parameter of this receive and process source function is the message containing the aforementioned response or responses.

There now follows a discussion, still in the context of the variant of the new radiocommunication module control technique according to the invention, of the case where customer task application no.2 plays the role of a supervision application. In this case, the secondary customer sub-application 8 is able for example to carry out the following processing operations:
implementation of a command switching mechanism, that allows the secondary customer sub-application 8 to filter or spy on the commands coming from the external customer application;
implementation of a response switching mechanism, that allows the secondary customer sub-application 8 to filter or spy on the responses intended for the external customer application.

These examples of processing operations carried out by the secondary customer sub-application are not described below in detail. However it will be noted that an explanatory text relating to the implementation by the secondary customer sub-application of the two aforementioned switching mechanisms (commands and responses respectively) can be obtained by making the following transposition:
we depart from the explanatory text above in the event of the customer task application no.2 being “single block”, and
it is considered that it is the secondary customer sub-application which is involved (instead of customer task application no.2).

In appendix 1 will be found a detailed presentation of some level 1 source functions, on which the customer initialisation applications 6a and the customer task applications 6b, 6c are based.

In appendix 2 will be found a detailed presentation of some level 2 source functions on which the customer task application no.2 and the main and secondary (in the case of the variant) customer sub-applications, introduced in the context of the new radiocommunication module control technique according to the invention, are based (see description above in relation to FIG. 8).

Appendix 1

Detailed Presentation of Some Level 1 Source Functions, on which the Customer Initialisation Application and the Customer Task Applications are Based.

Preliminary observation: the following list is not exhaustive. It will be noted that all the examples of level 1 source functions, associated with the customer task applications, relate to the “OS” block. Even if they do not feature on the list below, it is clear that there are a great many level 1 source functions, associated with the customer task applications, which relate to the “HWL” and “layer 3 GSM” blocks (an example of a function relating to each of these two blocks can be found in the explanations above given in relation to the figures.

A1) “wm_apmGlobalInit_level1( )

Level 1 global initialisation source function, the role of which is to provide the main software program 3 with information allowing it to initialise and to interact with each customer task application 6b, 6c.

A2) “apmAppliInit nx level1( )

Level 1 initialisation source function that allows a customer task application no.x to be initialised. This function is called upon once when the relevant customer task application is initialised.

Exact Name:

void AppliInit1(wm_apmInitTypw_e InitType);

Parameters:

InitType

indicates the item launching the initialisation. The corresponding values are:

typedef enum

| | |
|---|---|
| { | |
| | WM_APM-POWER_ON, |
| | WM_APM_REBOOT_FROM_EXCEPTION |
| } | wm_apmInitType_e; |

WM_APM-POWER_ON signifies that a normal power-up has occurred.

WM_APM_REBOOT_FROM_EXCEPTION signifies that the module has been rebooted following an exception.

A3) “apmAppliParser_nx_level1( )”

Level 1 source function of receiving and processing a message from the main software program. This function is called upon each time a customer application receives a message from the main software program.

Exact Name:

bool AppliParser1(wm_apmMsg_t*Message);

Parameters:

| Message: | |
|---|---|
| The “Message” structure depends on its type: | |
| typedef struct | |
| { | |
| u16 | |
| u16 | |
| s16 | |
| s16MbxSrc; | |
| MbxDst; | |
| Length; | |
| TypMsg;/*Source mailbox*/ | |
| /*Addressee mailbox*/ | |
| /*Length of message body*/ | |
| /*type of message received: indicates the structure | |
| associated with the message body*/ | |
| }wm_apmHeader_t; | |
| typedef struct | |
| { | |
| | wm_apmHeader_t Header; /*message header*/ |
| | wm_apmBody_t Body; /*specific message body*/ |
| } | wm_apmMsg_t; |

TypMsg may assume the following values:
WM_OS_TIMER:
signifies that the message is sent on expiry of a time
delay.WM_HWL_xxx ...

WM_L3xxx ...

Returned Values:

The return parameter indicates whether the message has been processed (true) or not (false).

A4) “Global Task Information”

| | |
|---|---|
| define WM_OS_MAX_CUST_TASK | 4 |

/*customer task application (or “customer task”)
identifiers*/
enum
{

| | |
|---|---|
| WM_OS_CUST_TASK_1, | /*High priority task*/ |
| WM_OS_CUST_TASK_2, | |
| WM_OS_CUST_TASK_3, | |
| WM_OS_CUST_TASK_4, | /*Low priority task*/ |
| }; | |
| /*Mailbox identifiers*/ | |
| typedef enum | |
| { | |

/*Customer task mailbox (MBX) identifiers*/

| | | |
|---|---|---|
| WM_OS_MBX_CUST_1/*MBX | associated | with |
| WM_OS_CUST_TASK_1*/ | | |
| WM_OS_MBX_CUST_2/*MBX | associated | with |
| WM_OS_CUST_TASK_2*/ | | |
| WM_OS_MBX_CUST_3/*MBX | associated | with |
| WM_OS_CUST_TASK_3*/ | | |
| WM_OS_MBX_CUST_4/*MBX | associated | with |
| WM_OS_CUST_TASK_4*/ | | |

/*Main software program task mailbox (MBX)
identifiers*/
WM_OS_MBX_CORE_CC,/* associated with Call Control
management*/
WM_OS_MBX_CORE_SS,/* associated with Supplementary

| | |
|---|---|
| Services | management*/ |

WM_OS_MBX_CORE_SMS,/* associated with Short Message
Services management)*/
WM_OS_MBX_CORE_MM,/* associated with Mobility
management)*/
WM_OS_MBX_CORE_RR,/* associated with Radio Resource
management)*/
WM_OS_MBX_CORE_DATA,/* associated with Data Call
management*/
WM_OS_MBX_CORE_IR,/* associated with Infrared
management)*/
WM_OS_MBX_CORE_IP,/* associated with IP management*/
WM_OS_MBX_CORE_SIM,/* associated with SIM management*/
/*HWL and BATT mailbox (MBX) identifiers*/
WM_OS_MBX_CORE_HWL,/* associated with HWL management*/
WM_OS_MBX_CORE_BATT,/ associated with Battery
management*/
}Mbx_t;

A5)“wm_osSendMsg_level1( )”

Level 1 source function of sending a message (previously allocated and completed) to another customer task application, via the interface application and the main software program.

Exact Name

bool wm_osSendMsg (void*Msg)

Parameters:

Msg: the message to be sent

Returned Values:

The return parameter indicates whether the message has been sent (true) or not (false).

A6) “wm_osStartTimer_level1”

Level 1 source function of triggering a time delay in the main software program.

A7) “wm_osStopTimer_level1”

Level 1 source function of stopping a time delay previously triggered in the main software program.

A8) “wm_osDebugTrace_level1”

Level 1 source function of tracing the debugging operation

A9) “wm_osDebugFatalError_level1”

Level 1 source function of indicating a fatal error and of rebooting

A10) “wm_osWriteFlashData_level1”

Level 1 source function of writing data in a memory included in the radiocommunication module

A11) “wm_osReadFlashData_level1”

Level 1 source function of reading data in a memory included in the radiocommunication module

A12) “wm_osGetLenFlashData_level1”

Level 1 source function of providing the length of data stored in a memory included in the radio communication module

A13) “wm_osDeleteFlashData_level1”

Level 1 source function of deleting data stored in a memory included in the radiocommunication module

A14) “wm_osGetAllowedMemoryFlashData_level1”

Level 1 source function of providing the quantity of memory allocated within a memory included in the radiocommunication module

A15) “wm_osGetFreeMemoryFlashData_level1”

Level 1 source function of providing the quantity of free memory within a memory included in the radiocommunication module

A16) “wm_osGetMemoryFlashData_level1”

Level 1 source function of requesting memory allocation within a memory included in the radiocommunication module

A17) “wm_osReleaseMemoryFlashData_level1”

Level 1 source function of requesting the release of memory within a memory included in the radiocommunication module.

A18) “wm_MbxSubscribe”

Level 1 source function of subscribing to a mailbox service managed by the main software program, allowing the customer task application to get itself allocated a mailbox which is specific to it and in which it wishes to receive information coming from at least one predetermined source.

The default setting is for all the information to be sent to WM_OS_CUST_MBX_{—}1, i.e. to the mailbox associated with WM_OS_CUST_TASK_{—}1 (customer task application no.1).

Exact Name:

bool

wm_MbxSubscribe(wm_apmMbxSubscription_t*TabMbxSubs);

Parameters:

TabMbsSubs:

Table containing the entities and their associated mailboxes.

Typedef struct

{
Mbx_t MbxSrc;/* source mailbox, identifies one of the
WM_OS_CORE_MBX_x*/
Mbx_t MbxDst; /* destination mailbox, identifies one
of the WM_OS_CUST_MBX_x*/
} wm_apmMbxSubscription_t;

Returned Values:

The return parameter indicates whether the subscription has been processed (true) or not (false).

Appendix 2:

Detailed Presentation of Some Level 2 Source Functions, on which are Based Customer Task Application No.2 and the Main and Secondary Customer Sub-Applications (in the Case of the Variant), Introduced in the Context of the New Radiocommunication Module Control Technique According to the Invention.

Preliminary observation: the following list is not exhaustive.

A1) “wm_osMsgParserSubscribe_level2( )”

function of subscribing customer task application no.2 or a (main or secondary) customer sub-application, with customer task application no.1, to a service for receiving messages from customer task application no.1. Customer task application no.1 stores this function and will use it each time it has something to transmit to the (main or secondary) customer sub-application involved.

Exact Name:

void

wm_osMsgParserSubscribe_level2(void(*SubscribeFunction) (wm_apmMsg_t*));

Parameters:

SubscribeFunction(wm_apmMsg_t*): a function offered by the calling party (customer task application no.2 or (main or secondary) customer sub-application so that the software program can send it messages. A prototype of this function offered is detailed below (“wm_apmAppliParser_level2” for the main customer sub-application, or “wm_app2MsgParser_level2” for the secondary customer sub-application).

Returned Value:

The return parameter indicates whether the subscription has been processed (TRUE) or not (FALSE).

A2)“wm_osMsgParserUnsubscribe_level2( )”

function of stopping the subscription of customer task application no.2, or of a (main or secondary) customer sub-application, with customer task application no.1, to a service for receiving messages coming from customer task application no.1. Customer task application no.1 forgets the previously stored function.

Exact Name:

boolwm_osMsgParserUnsubscribe_level2(void(*SubsFunction)(wm_apmMsg_t*));

Parameters:

SubsFunction(wm_apmMsg_t*): function offered by the calling party (customer task application no.2 or (main or secondary) customer sub-application) so that customer task application no.1 is able to send it messages. This function must be the same as that given at the time of subscribing to this service, otherwise the subscription stop will not be processed.

Returned Value:

The return parameter indicates whether the subscription stop has been processed (TRUE) or not (false)

A3)“wm_app2Pipe_level2(FunctionTypefunction, . . . )”

Prototype of the function which the secondary customer sub-application must offer the main customer sub-application in order to interact with it. This is a variable argument function, the number and type of arguments depends on the first “function” parameter.

Exact Name:

void wm_app2Pipe_level2(FunctionTypefunction . . . );

Parameters:

function: function requested. It implies the number and the type of the following parameters. Some values are reserved (for example from 0 to 127), the others (for example from 128 to 255) are left free for use by particular dialogues between the main customer sub-application and the secondary customer sub-application.

| | |
|---|---|
| A3-1)Variableparameters | for |

| function=WM_APP_FUNCTION_INIT: | |
|---|---|
| void wm_app2Pipe_level2 ( | |
| FunctionType_t function, | |
| InitType_t Init, | |
| void | (*MainAppDialogFunction) (wm_apmMsg_t*), |
| void | |

*(*SecondaryAppDialogFunction) (wm_apmMsg_t*),
);

The secondary sub-application must be initialised and do its processing.

InitType_t Init: the initialisation type (APM_INIT_POWER_ON or APM_INIT_REBOOT)

void(*MainAppDialogFunction) (wm_apmMsg_t*): function address which must be used by the secondary customer sub-application to send messages to the main customer sub-application. If such a function is not required by the main customer sub-application, it gives a NULL value.

void: *(* SecondaryAppDialogFunction)(wm_apmMsg_t*): The secondary customer sub-application must give the address of the function it offers the main customer sub-application. If the secondary customer sub-application does not offer this function, it must set the value to NULL

| | | | |
|---|---|---|---|
| (A3-2) | Varaible | parameters | for |

function=WM_APP_FUNCTION_STOP:
void wm_app2Pipe_level2 (
FunctionType_t function
);

The secondary customer sub-application must stop its processing operations, unsubscribe from all its subscriptions, and release all the resources used.

A4) “wm_apmAppliParser_level2”

Prototype of the source function that customer task application no.2 must offer in order to receive messages from customer task application no.1. The parameter forming message of this processing (also known as “receive”) function contains particularly an AT command or a response to an AT command.

It will be noted that everything which is described below also applies to the source function, in which the main customer sub-application or the secondary customer sub-application wishes to receive messages coming from the customer task application no.1. Only the name of the function itself changes (for example “wm_app2MsgParser_level2” instead of “wm apmAppliParser_level2”).

Exact Name:

bool wm_apmAppliParser_level2(wm_apmMsg_t*Message);

Parameters

Message

The structure of the message changes with each type of message received:

typedef struct
{

| | |
|---|---|
| s16 | MsgTyp; |

| /*“MsgTyp” is a received message type, which | | |
|---|---|---|
| allows the associated message body structure to | | |
| be determined*/ | | |
| wm_apmBody_t | Body; | /*“Body” is a specific |
| message body*/ | | |

} wm_apmMsg_t;

Values of “MsgTyp”:

WM_AT_SEND_RSP

The message contains a response to an AT command previously sent to customer task application no.1 by customer task application no.2

WM_AT_UNSOLICITED

The message contains an unsolicited AT command

WM_AT_CMD_PRE_PARSER

The message contains an AT command sent by an external customer application, via customer task application no.1

WM_AT_RSP_PRE_PARSER

The message contains an AT response arising from the execution by customer task application no.1 of an AT command coming from an external application.

WM_OS_TIMER

The message is sent on the expiry of a time delay.

The structure of the body is:

typedef union
{

| /*Are included here all the specific | |
|---|---|
| structures associated with message types | |
| “MsgTyp” | */ |
| /*WM_AT_SEND_RSP | */ |
| wm_atResponse_t | ATResponse; |
| /*WM_AT_UNSOLICITED | */ |
| wm_atUnsolicited_t | ATUnsolicited; |
| /*WM_AT_CMD_PRE_PARSER | */ |
| wm_atCmdPreParser_t | ATCmdPreParser; |
| /*WM_AT_RSP_PRE_PARSER | */ |
| wm_atRspPreParser_t | ATRspPreParser |
| /*WM_OS_TIMER | */ |

| | |
|---|---|
| wm_osTimer_t | OSTimer; |

}wm_apmBody_t;

The sub-structures of the body are:

Body for WM_AT_SEND_RSP:

| | |
|---|---|
| typedef struct | { |

| wm_atSendRspType_e Type; | | |
|---|---|---|
| u16 | StrLength; | /*Length of |
| strData*/ | | |

| | |
|---|---|
| char | StrData[1]; /*AT response*/ |

| }wm_atResponse_t; | |
|---|---|
| typedef enum | { |

WM_AT_SEND_RSP_TO_EMBEDDED,
WM_AT_SEND_RSP_TO_EXTERNAL,
WM_AT_SEND_RSP_TO_BROADCAST

}wm_atSendRspType_e;
(see the detail on the “wm_atSendCommand_level2”
function, for the description of
“wm_atSendRspType_e description”).

Body for WM_AT_UNSOLICITED:

| | |
|---|---|
| typedef struct | { |

| wm_atUnsolicited_e Type; | |
|---|---|
| u16 | StrLength; |
| char | StrData[1]; |

| }wm_atUnsolicited_t; | |
|---|---|
| typedef enum | { |

WM_AT_UNSOLICITED_TO_EXTERNAL,
WM_AT_UNSOLICITED_TO_EMBEDDED,
WM_AT_UNSOLICITED_TO_BROADCAST

| }wm_atUNSOLICITED_e; | | | | |
|---|---|---|---|---|
| (see | the | detail | on | the |

“wm_atUnsolicitedSubscription_level2” function,
for the description of “wm_atUnsolicited_e”).

Body for WM_AT_CMD_PRE_PARSER:

| | |
|---|---|
| typedef struct | { |

| wm_atCmdPreSubscribe_e Type; | |
|---|---|
| u16 | StrLength; |
| char | StrData[1]; |

| }wm_atCmdPreParser_t; | |
|---|---|
| typedef enum | { |

WM_AT_CMD_PRE_WAVECOM_TREATMENT,/*Defaultvalue
*/
WM_AT_CMD_PRE_EMBEDDED_TREATMENT,
WM_AT_CMD_PRE_BROADCAST

}wm_atCmdPreSubscribe_e;
(see the detail on the function
“wm_atRspPreParserSubscribe_level2”, for the
description of “wm_atCmdPreSubscribe_e”).

Body for WM_AT_RSP_PRE_PARSER:

| | |
|---|---|
| typedef struct | { |

| wm_atRspPreSubscribe_e Type; | |
|---|---|
| u16 | StrLength; |
| char | StrData[1]; |

| }wm_atRspPreParser_t; | |
|---|---|
| typedef enum | { |

WM_AT_RSP_PRE_WAVECOM_TREATMENT,/*Defaultvalue
*/
WM_AT_RSP_PRE_EMBEDDED_TREATMENT,
WM_AT_RSP_PRE_BROADCAST

}wm_atRspPreSubscribe_e;
(see the detail on the function
“wm_atRspPreParserSubscribe_level2”, for the
description of “wm_atRspPreSubscribe_e”).

Body for WM_OS_TIMER:

typedef struct {

| | | |
|---|---|---|
| u8 | Ident; | /*Time Delay |
| Identifier*/ | | |

}wm_osTimer_t;
(see the detail on the “wm_osStartTimer_level2”
function, for the description of “Ident”).

Returned Values

The return parameter indicates whether the message has been processed (TRUE) or not (FALSE).

A5) “wm_atSendCommand_level2”

function of sending to customer task application no.1 at least one AT command, one parameter of which indicates the applications (namely the embedded customer task application no.2 (or the (main or secondary) customer sub-application) and/or the external customer application) to which the response arising from the execution of this AT command is addressed.

Exact Name

| | |
|---|---|
| void wm_atSendCommand_level2 (u16 | AtStringSize, |

| wm_atSendRspType_e | |
|---|---|
| ResponseType, | |
| char | *AtString,); |

Parameters
AtString

This parameter can be any type of AT command string, in ASCII characters. Several strings may be sent at the same time

AtStringSize

Size of the previous parameter: AtString.

Response Type

Type of response

| | |
|---|---|
| typedef enum | { |

WM_AT_SEND_RSP_TO_EMBEDDED, /*Default
value*/
WM_AT_SEND_RSP_TO_EXTERNAL
WM_AT_SEND_RSP_BROADCAST

}wm_atSendRspType_e;

WM_AT_SEND_RSP_TO_EMBEDDED

All the responses are redirected to the embedded customer task application no.2 (or the (main or secondary) customer sub-application. This is the default mode

WM_AT_SEND_RSP_TO_EXTERNAL

All the responses are redirected to the external customer application (PC).

WM_AT_SEND_RSP_BROADCAST

All the responses are redirected (“broadcast”) to the embedded customer task application no.2 (or the (main or secondary) customer sub-application) and the external customer application (PC).

A6) “wm_atUnsolicitedSubscription_level2”

function of subscribing with customer task application no.1 to an unsolicited AT command reception service, one parameter of which indicates to which addressee applications (namely the embedded customer task application no.2 (or the (main or secondary) customer sub-application) and/or the external customer application) each of the unsolicited AT commands is to be redirected.

Exact Name:

void

wm_atUnsolicitedSubscription_level2(wm_atUnsolicited_e Unsolicited);

Parameters:

Unsolicited

This parameter describes the action carried out when an unsolicited AT command arrives.

| | | |
|---|---|---|
| typedef | enum | { |

WM_AT_UNSOLICITED_TO_EXTERNAL, /*Default
value*/
WM_AT_UNSOLICITED_TO_EMBEDDED,
WM_AT_UNSOLICITED_broadcast

}wm_atUnsolicited_e;

WM_AT_UNSOLICITED_TO_EXTERNAL

All unsolicited commands will be redirected to the external customer application (PC) (default mode)

WM_AT_UNSOLICITED_TO_EMBEDDED,

All unsolicited commands will be redirected to the embedded customer task application no.2 (or the (main or secondary) customer sub-application)

WM_AT_UNSOLICITED_broadcast

All unsolicited commands will be redirected (broadcast) to the external customer application (PC) and the embedded customer task application no.2 (or the (main or secondary) customer sub-application).

A7) “wm_atCmdPreParserSubscribe_level2”

function of subscribing with customer task application no.1 to an AT command switching service, one parameter of which indicates to which addressee applications (namely the embedded customer task application no.2 (or the (main or secondary) customer sub-application) and/or customer task application no.1) each of the AT commands coming from an external application is to be switched.

Exact Name:

| | |
|---|---|
| void | wm_atCmdPreParserSubscribe_level2 |

(wm_atCmdPreSubscribe_e SubscribeType)

Parameters:

This parameter describes the action taken when an AT command arrives

| | | |
|---|---|---|
| typedef | enum | { |

WM_AT_CMD_PRE_WAVECOM_TREATMENT, /*Default
mode*/
WM_AT_CMD_PRE_EMBEDDED_TREATMENT
WM_AT_CMD_PRE_BROADCAST

}wm_atCmdPreSubscribe_e;

WM_AT_CMD_PRE_WAVECOM_TREATMENT

The embedded customer task application no.2 (or the (main or secondary) customer sub-application) does not want to filter (or to spy on) the commands sent by the external customer application (default mode).

WM_AT_CMD_PRE_EMBEDDED_TREATMENT

The embedded customer task application no.2 (or the (main or secondary) customer sub-application wants to filter the commands sent by the external customer application

WM_AT_CMD_PRE_BROADCAST

The embedded customer task application no.2 (or the (main or secondary) customer sub-application wants to spy on the commands sent by the external customer application

A8) “wm_atRspPreParserSubscribe_level2”

function of subscribing with customer task application no.1 to an AT response switching service, one parameter of which indicates to which addressee applications (namely the embedded customer task application no.2 (or the (main or secondary) customer sub-application) and/or the external customer application) each of the AT responses arising from the execution by customer task application no.1 of an AT command coming from an external application is to be switched.

Exact Name:

void wm_atRspPreParserSubscribe_level2

wm_atRspPreSubscribe_e SubscribeType

Parameters:

This parameter describes the action taken when an AT command arrives

| | | |
|---|---|---|
| typedef | enum | { |

WM_AT_RSP_PRE_WAVECOM_TREATMENT/*Default
value*/
WM_AT_RSP_PRE_EMBEDDED_TREATMENT
WM_AT_RSP_PRE_BROADCAST

}wm_atRspPreSubscribe_e;

WM_AT_RSP_PRE_WAVECOM_TREATMENT

The embedded customer task application no.2 (or the (main or secondary) customer sub-application) does not want to filter (or to spy on) the responses sent by the external customer application (default mode).

WM_AT_RSP_PRE_EMBEDDED_TREATMENT

The embedded customer task application no.2 (or the (main or secondary) customer sub-application) wants to filter the responses sent by the external customer application

WM_AT_RSP_PRE_BROADCAST

The embedded customer task application no.2 (or the (main or secondary) customer sub-application) wants to spy on the responses sent by the external customer application

A9) “wm_atSendRspExternalApp_level2”

function of sending to the external customer application, via customer task application no.1, at least one response. The use of this function is only possible if a previous subscription has been made to the response switching service, with the switching of one copy of the responses particularly to the embedded customer task application no.2 (or the (main or secondary) customer sub-application).

Exact Name:

| | |
|---|---|
| void wm_atSendRspExternalApp_level2 (u16 | AtStringSize, |

| | |
|---|---|
| char | *AtString,); |

Parameters:
AtString

can be any type of AT response string, in ASCII characters

AtStringSize

Size of the previous parameter: AtString

A10) Data Flow Service Level 2

function of sending and/or receiving data by the embedded customer task application no.2 (or the (main or secondary) customer sub-application), via customer task application no.1, after a data communication has been set up.

1. A radiocommunication module of the type that hosts and runs a main software program including:
an operating system management application,
a radio communication management application,
an application for managing peripheral devices that can be connected to the radio communication module,
characterised in that each of said applications included in the main software program is associated with a set of level 1 executive functions,
in that said radio communication module additionally hosts and runs at least one customer software program including at least one customer application, associated with a set of level 1 source functions,
and in that said main software program and/or said customer software program include(s) a level 1 interface application, allowing level 1 source functions, associated with said customer application, to interface with level 1 executive functions, associated with said operating system management application and with at least one of said radio communication management and peripheral device management applications, so as to open up, to at least one customer application, access to at least some of the functionalities of the main software program.

2. Radiocommunication module according to claim 1, characterized in that said interface application is included in said customer software program.

3. Radiocommunication module according to claim 1, characterized in that said customer software program includes a binary file containing at least two customer applications.

4. Radiocommunication module according to claim 1, characterized in that said customer software program includes at least two binary files, each containing at least one customer application.

5. Radiocommunication module according to claim 1, characterized in that said customer software program includes a global initialization customer application, and at least one customer task application carrying out at least one real-time task,
and in that the set of level 1 source functions associated with the global initialization customer application includes a level 1 global initialization source function, the role of which is to provide the main software program with information allowing it to initialize and to interact with each customer task application.

6. Radiocommunication module according to claim 1, characterized in that said customer software program includes at least two customer task applications, each associated with a set of level 1 source functions and each carrying out at least one distinct real-time task,
and in that said main software program and/or said customer software program include(s) means of sharing out calculation resources between said customer task applications, so as to allow a real-time multi-task operation.

7. Radiocommunication module according to claim 5, characterized in that the set of level 1 source functions associated with each customer task application includes a level 1 initialization source function, allowing said customer task application to be initialized.

8. Radiocommunication module according to claim 7, characterized in that said information provided by the global initialization source function to the main software program includes:
the number of customer task applications to be initialized;
for each customer task application to be initialized, the corresponding level 1 initialization source function.

9. Radiocommunication module according to claim 5, characterized in that the set of level 1 source functions associated with each customer task application includes a level 1 source function of receiving and processing a message from the main software program, one parameter of said level 1 receive and process source function being said message.

10. Radiocommunication module according to claim 9, characterized in that said information provided by the level 1 global initialization source function to the main software program includes additionally:
for each customer task application to be initialized, the level 1 receive and process source function.

11. Radiocommunication module according to claim 5, characterized in that the set of level 1 source functions associated with each customer task application includes a level 1 source function of subscribing to a mailbox service managed by the main software program, allowing said customer task application to get itself allocated a mailbox which is specific to it and in which it wishes to receive information coming from least one predetermined source.

12. Radio communication module according to claim 11, characterized in that each predetermined information source is a mailbox allocated to at least one main task carried out by the main software program, and containing information which said main task wishes to communicate to one or more other entities.

13. Radio communication module according to claim 1, characterized in that said customer software program includes at least one customer task application, associated with a set of level 1 source functions and each carrying out at least one distinct real-time task,
and in that the set of level 1 source functions associated with each customer task application includes at least one function belonging to the group including:
a level 1 source function of sending a message (previously allocated and completed) to another customer task application, via said interface application and said main software program;
a level 1 source function of triggering a time delay in said main software program;
a level 1 source function of stopping a time delay previously triggered in said main software program;
a level 1 source function of tracing the debugging;
a level 1 source function of showing a fatal error and rebooting;
a level 1 source function of writing data into a memory included in the radiocommunication module;
a level 1 source function of reading data in a memory included in the radiocommunication module;
a level 1 source function of providing the length of data stored in a memory included in the radiocommunication module;
a level 1 source function of deleting data stored in a memory included in the radiocommunication module;
a level 1 source function of providing the quantity of memory allocated within a memory included the radiocommunication module;
a level 1 source function of providing the quantity of free memory within a memory included the radiocommunication module;
a level 1 source function of requesting memory allocation within a memory included the radiocommunication module;
a level 1 memory of requesting the release of memory within a memory included in the radiocommunication module.

14. Radiocommunication module according to claim 1, characterized in that the embedded customer software program and the main software program each use a different part of the same random access memory, an attempt by one of the software programs to access a part of the random access memory reserved for the other software program causing a stop in operation.

15. Radiocommunication module according to claim 1, characterized in that it is included in a device belonging to the group including:
radiocommunication terminals;
devices, other than radiocommunication terminals, requiring a wireless communication functionality;
modems.

16. Radiocommunication module according to claim 1, characterised in that said customer software program includes at least:
a first customer application carrying out a first real-time task of executing control commands, sent to said first application by at least one customer control application and belonging to a predetermined set of control commands, said first customer application being based particularly on a set of level 2 executive functions, specific to the control commands and each allowing at least one of said control commands to be executed,
a second customer application carrying out a second real-time task such that said second customer application plays at least one of the following roles:
the role of a customer control application, sending control commands to the first customer application, and receiving from the customer application responses arising from the execution of some of the control commands;
the role of a customer supervision application, managing the execution of control commands sent by a customer control application, said customer application being external, hosted and run by third party equipment engaging with the radiocommunication module;
said second customer application being based particularly on a set of level 2 source functions, specific to the control commands and each allowing control commands or responses to control commands to be sent or received, to or from the first customer application,
a level 2 interface application, specific to the control commands, allowing said level 2 source and executive functions to interface, said level 2 interface application itself being based on said level 1 interface application.

17. Radiocommunication module according to claim 16, characterized in that, to allow the second customer application to play the role of a customer control application:
the second customer application includes means of sending control commands to the executive means included in the first customer application;
the first customer application includes means of sending responses, arising from the execution of some of the control commands by the executive means included in the first customer application, to the second customer application;
the second customer application includes means of processing the responses sent to it by the first customer application.

18. Radiocommunication module according to claim 16, characterized in that, to allow the second customer application to play the role of a customer supervision application:
the first customer application includes command switching means, as a function of a pre-set command switching policy, so as to transmit the control commands coming from the external customer application to the second customer application and/or to the executive means included in the first customer application;
the second customer application includes means of processing the control commands switched to it by said command switching means.

19. Radiocommunication module according to claim 18, characterized in that the second customer application includes means of selecting the command switching policy applied by said command switching means, among a set of command switching policies such that respectively:
the control commands from the external customer application are transmitted only to the executive means included in the first customer application;
the control commands from the external customer application are transmitted only to the second customer application;
the control commands from the external customer application are transmitted to the executive means included in the first customer application and the second customer application.

20. Radiocommunication module according to claim 18, characterized in that said command processing means take, for each command, at least one decision belonging to the group that includes:
sending the control command to the executive means included in the first customer application, the second customer application including to this end means of sending control commands to the executive means;
providing or not providing a response, solely as a function of at least one piece of information relating to the command, without executing the command, the second customer application including to this end means of sending the response to the external customer application, via the second customer application.

21. Radiocommunication module according to claim 16, characterized in that, to allow the second customer application to play the role of a customer supervision application:
the first customer application includes response switching means, as a function of a pre-set response switching policy, so as to transmit responses, arising from the execution of some of the control commands by the executive means included in the first customer application, to the second customer application and/or to the external customer application;
the second customer application includes means of processing responses switched to it by said response switching means.

22. Radiocommunication module according to claim 21, characterized in that the second customer application includes means of selecting the response switching policy applied by said response switching means, among a set of response switching policies such that respectively:
the responses from the executive means are transmitted solely to the external customer application;
the responses from the executive means are transmitted solely to the second customer application;
the responses from the executive means are transmitted to the second customer application and to the external customer application.

23. Radiocommunication module according to claim 16, characterized in that said set of level 2 source functions includes particularly a function of processing a message from the first application, one parameter of said processing function being said message.

24. Radiocommunication module according to claim 23, characterized in that said message forming a parameter of said processing function has a structure including:
a first field containing a piece of information relating to the type of said message;
a second field containing the specific body of said message.

25. Radiocommunication module according to claim 24, characterized in that the type of said message belongs to the group including:
a message containing a response to a control command previously sent to the first application by the second application;
a message containing an unsolicited control command;
a message containing a control command sent by an external customer application, via the first application;
a message containing a response arising from the execution by the first application of a control command sent by the external customer application;
a message sent on expiry of a time delay.

26. Radiocommunication module according to claim 23, characterized in that said set of level 2 source functions additionally includes at least one function belonging to the group including:
a level 2 source function of sending to the first application at least one control command, a first parameter of said send function being said at least one control command, a second parameter of said send function indicating the application(s), namely the second application and/or the external customer application, to which the response arising from the execution of said control command is to be addressed;
a level 2 source function of subscribing with the first application to a service of receiving unsolicited control commands, one parameter of said subscription function indicating to which addressee applications, namely the second customer application and/or the external customer application, each of the unsolicited control commands is to be redirected;
a level 2 source function of subscribing with the first application to a control command switching service, one parameter of said subscription function indicating to which applications, namely the first application and/or the second application, each of the control commands from the external customer application is to be switched;
a level 2 source function of subscribing with the first application to the response switching service, one parameter of said subscription function indicating to which application(s), namely the external customer application and/or the second application, each of the responses arising from the execution by the first application of a control command is to be switched;
a level 2 source function of sending to the external customer application, via the first application, at least one response, one parameter of said send function being said at least one response.

27. Radiocommunication module according to claim 16, characterized in that said set of control commands is a standard set of AT commands.

28. Radiocommunication module according to claim 27, characterized in that said set of control commands includes, apart from the standard AT commands, an additional AT command (AT+WDWL), known as a load command, allowing the external customer application to load a new second customer application or the totality of a new customer software program in the radiocommunication module.

29. Radiocommunication module according to claim 27, characterizsed in that said set of control commands includes, apart from the standard AT commands, an additional AT command, known as the disabling command, allowing the external customer application to disable the second customer application.

30. Radiocommunication module according to claim 16, characterized in that said second customer application includes a main customer sub-application and at least one secondary customer sub-application, slave of the main customer sub-application, the processing operations carried out by said second customer application being shared out between said main customer sub-application and said least one secondary customer sub-application.

31. Radiocommunication module according to claim 30, characterized in that said customer software program includes a global initialization customer application, and at least one customer task application carrying out at least one real-time task,
and in that the set of level 1 source functions associated with the global initialization customer application includes a level 1 global initialization source function, the role of which is to provide the main software program with information allowing it to initialize and to interact with each customer task application,
and in that the set of level 1 source functions associated with each customer task application includes a level 1 initialization source function, allowing said customer task application to be initialized,
and it that said level 1 initialization source function is included in the set of level 1 source functions associated with the second customer task application and allows said main customer sub-application to be initialized.

32. Radiocommunication module according to claim 31, characterized in that the main customer sub-application is associated with a set of level 2 source functions including a level 2 source function of subscribing to a service of sending messages from the first customer application,
and in that at this subscription, the main customer sub-application sends the first customer application the address of a level 2 message processing source function, in which the main customer sub-application wishes to receive messages from the first customer application.

33. Radiocommunication module according to claim 30, characterized in that the secondary customer sub-application is associated with a set of level 2 source functions including a level 2 source function of initializing the secondary customer sub-application, which is called upon by the main customer sub-application.

34. Radiocommunication module according to claim 33, characterized in that the set of level 2 source functions associated with the secondary customer sub-application includes a level 2 source function of subscribing to a service of sending messages from the first customer application,
and in that at this subscription, the secondary customer sub-application sends the first customer application the address of a level 2 message processing source function, in which the secondary customer application wishes to receive messages from the first customer application.

35. Radiocommunication module according to claim 33, characterized in that said level 2 source function of initializing the secondary customer sub-application includes at least one parameter allowing a dialogue mechanism to be implemented between the main customer sub-application and the secondary customer sub-application.

36. Radiocommunication module according to claim 33, characterized in that the set of level 2 source functions associated with the secondary customer sub-application includes a level 2 source function of stopping the secondary customer sub-application, which is called upon by the main customer sub-application.

37. Radiocommunication module according to claim 33, characterized in that the set of level 2 source functions associated with the secondary customer sub-application includes a level 2 source function of unsubscribing from said service of sending messages from the first customer application.

38. Process of opening up access to at least some of the functionalities of a main software program of a radiocommunication module, said radiocommunication module being of the type that hosts and runs a main software program including:
an operating system management application,
a radio communication management application,
an application for managing peripheral devices that can be connected to the radio communication module,
characterized in that each of said applications included in the main software program is associated with a set of level 1 executive functions,
in that said radio communication module additionally hosts and runs at least one customer software program including at least one customer application, associated with a set of level 1 source functions,
and in that said main software program and/or said customer software program include(s) a level 1 interface application, allowing level 1 source functions, associated with said customer application, to interface with level 1 executive functions, associated with said operating system management application and with at least one of said radio communication management and peripheral device management applications.
